(19) United States
(12) Patent Application Publication
(10) Pub. No.: US 2025/0337310 A1
(43) Pub. Date: Oct. 30, 2025

(54) METHODS AND APPARATUS TO BALANCE HALF BRIDGE CONVERTERS

(71) Applicant: Texas Instruments Incorporated, Dallas, TX (US)

(72) Inventors: Ramkumar S, Bangalore (IN); Benjamin Pan Lough, Carrollton, TX (US); John C. Vogt, Denton, TX (US); Akhila Gundavarapu, Bangalore (IN); Dipankar Mandal, Bangalore (IN)

(21) Appl. No.: 18/647,972

(22) Filed: Apr. 26, 2024

(51) Int. Cl. H02M 1/00; H02M 3/158

(52) U.S. Cl. CPC H02M 1/0025; H02M 1/007; H02M 3/158

(57) ABSTRACT

An example apparatus includes: monitor circuitry configured to: determine a first transistor within half bridge converter circuitry is powered on for a first amount of time during a switching cycle of the half bridge converter circuitry; determine a second transistor within the half bridge converter circuitry is powered on for a second amount of time during the switching cycle; and digital to analog converter (DAC) circuitry coupled to the monitor circuitry, the DAC circuitry configured to inject an amount of current into the half bridge converter circuitry to correct an error, the amount of the current based on a difference between the first amount of time and the second amount of time.

### TECHNICAL FIELD

This description relates generally to power supply circuitry, and, more particularly, to methods and apparatus to balance half bridge converters.

### BACKGROUND

Power management circuity is a critical design component of any electronic device. In general, power management circuitry refers to hardware and/or software that converts a first voltage and a first current received from a source into a second voltage and second current that is consumable by a load. Power sources may include, but are not limited to, 120 volts alternating current (VAC) or 240 VAC wall outlets, batteries, generators, power provided by solar cells, etc. Generally, power management circuitry may also convert the power from a first type (e.g., alternating current (AC)) to a second type (e.g., direct current (DC)) that is usable by the load.

### SUMMARY

For methods and apparatus to balance half bridge converters, an example apparatus includes monitor circuitry configured to: determine a first transistor within half bridge converter circuitry is powered on for a first amount of time during a switching cycle of the half bridge converter circuitry; determine a second transistor within the half bridge converter circuitry is powered on for a second amount of time during the switching cycle; and digital to analog converter (DAC) circuitry coupled to the monitor circuitry, the DAC circuitry configured to inject an amount of current into the half bridge converter circuitry to correct an error, the amount of the current based on a difference between the first amount of time and the second amount of time.

### BRIEF DESCRIPTION OF THE DRAWINGS

FIG. 1 is an example of power delivery that includes switching converter circuitry.

FIG. 2 is an example block diagram of the switching converter circuitry of FIG. 1.

FIG. 3A is an example block diagram of a first implementation of the Voltage Resonant Capacitor (VCR) synthesis circuitry of FIG. 2.

FIG. 3B is an example block diagram of a second implementation of the VCR synthesis circuitry of FIG. 2.

FIG. 4A is an example block diagram of a third implementation of the Voltage Resonant Capacitor (VCR) synthesis circuitry of FIG. 2.

FIG. 4B is a graph illustrating signals produced by the equalizer circuitry of FIG. 4A.

FIG. 5 is an example block diagram of the equalizer circuitry of FIGS. 3A, 3B, and 4A.

FIG. 6 is a graph illustrating operations of VCR synthesis circuitry that does not include the equalizer circuitry of FIGS. 3A, 3B, and 4A.

FIG. 7 is a graph illustrating operations of VCR synthesis circuitry that does include the equalizer circuitry of FIGS. 3A, 3B, and 4A.

FIG. 8 is a flowchart representative of example machine-readable instructions or example operations that may be executed, instantiated, or performed using an example programmable circuitry implementation of the equalizer circuitry of FIGS. 3A, 3B, and 4A.

FIG. 9 is a block diagram of an example processing platform including programmable circuitry structured to execute, instantiate, or perform the example machine-readable instructions or perform the example operations of FIG. 8 to implement the equalizer circuitry 320 of FIGS. 3A, 3B, and 4A.

The same reference numbers or other reference designators are used in the drawings to designate the same or similar (functionally and/or structurally) features.

### DETAILED DESCRIPTION

The drawings are not necessarily to scale. Generally, the same reference numbers in the drawing(s) and this description refer to the same or like parts. Although the drawings show regions with clean lines and boundaries, some or all of these lines and/or boundaries may be idealized. In reality, the boundaries and/or lines may be unobservable, blended and/or irregular.

In some examples, the difference between a first voltage used by a primary side of a circuit (e.g., the side connected to a voltage source) and a second voltage used by a secondary side of the circuit (e.g., the side connected to the load) is so great that designers and manufacturers seek to galvanically isolate the primary side and the secondary side from one another. Galvanic isolation generally refers to the principle of preventing a direct conduction path between sections of an electrically connected system. In some examples, galvanic isolation can improve the one or more of the safety and performance of the electrical system.

A wide variety of architectures can be used to implement power management circuitry that converts a first voltage to a second voltage in a galvanically isolated manner. One such architecture is a resonant converter. In general, a resonant converter is a type of power management circuitry that includes a network of inductors and capacitors that isolate the voltage source from the load. Rather than using a direct conduction path, the network of inductors and capacitors in resonant converter collectively resonate at a specific frequency such that energy is transferred from the voltage source to the load through the electromagnetic field that surrounds an inductor. In some examples, the network of inductors and capacitors is referred to as a resonant tank.

Industry members may integrate different types of resonant converter circuits into a device based on the use case. One such type of resonant converter circuit is a Half Bridge LLC. Half Bridge LLC resonant converters include two primary switches on the primary side of the circuit and two secondary switches that collectively act as a rectifier on the secondary side of the circuit. Half Bridge LLC resonant converters can perform zero voltage switching (ZVS) on the primary switches and zero current switching (ZCS) on the rectifiers. ZVS refers to the drain to source voltage of one or more primary switches being at zero volts (V) before the switch is turned on. Similarly, ZCS ensures the secondary switches are turned off in response to the current through the switch reaching zero Amps, avoiding the loss mechanism of reverse recovery. As a result, Half Bridge LLC resonant converters can operate at a high efficiency compared to other isolated power management architectures.

While ZVS and ZCS enable Half Bridge LLC resonant converters to operate at a relatively high efficiency, the performance of the circuit is still limited by imbalance that accumulates during current mode control. Current mode control (CMC) refers to a mode of operation in which the magnitude of the output voltage provided to the load is responsive to the amount of current flowing through the inductor that separates the primary side and secondary side of the current. CMC is generally considered faster than voltage mode control (VMC) because the feedback loop of CMC is internal (e.g., measurements occur at or near the inductor) while the feedback loop of VMC is external (e.g., measurements occur at or near occur the output provided to the load).

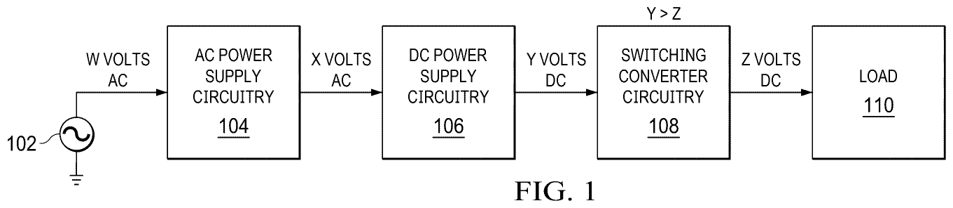

FIG. 1 is an example of power delivery that includes switching converter circuitry. FIG. 1 includes an example power source 102, an example AC power supply circuitry 104, example DC power supply circuitry 106, example switching converter circuitry 108, and an example load 110.

The power source 102 provides AC power. The power source 102 may be implemented by any device providing electrical energy in AC. For example, in FIG. 1, the example power source 102 is implemented by a 120 VAC outlet.

The AC power supply circuitry 104 transforms the 120 VAC into a different AC signal that is operable upon by the DC power supply unit. In particular, the AC power supply circuitry 104 may alter one or more of the voltage, frequency, shape of signal, number of phases, etc., depending on the type of the power source 102 and the requirements of the DC power supply unit.

The DC power supply circuitry 106 transforms the AC signal received from the AC power supply circuitry 104 into a DC signal. The DC power supply circuitry 106 includes rectifier circuitry and filter circuitry to convert the AC signal to a DC signal. The DC power supply circuitry 106 can provide a DC signal at a voltage that is operable by the switching converter circuitry 108. In some examples, the DC power supply circuitry 106 is referred to as a voltage source.

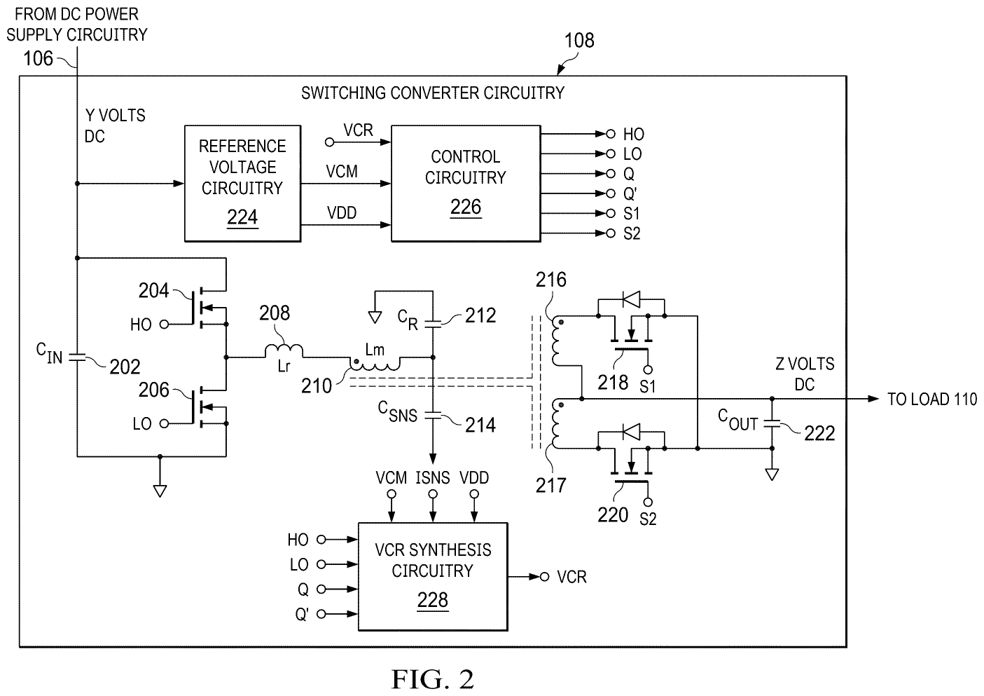

The switching converter circuitry 108 transforms, as described herein, the first DC voltage provided by the example DC power supply circuitry 106 into a second DC voltage usable by the load 110. The switching converter circuitry 108 is described further in connection with FIG. 2.

In FIG. 1, the example load 110 is an electronic device that uses the second DC voltage to perform operations. The load 110 may be implemented as any type of electronic device, including but not limited to programmable circuitry, a transceiver, volatile memory, etc.

FIG. 2 is an example block diagram of the switching converter circuitry of FIG. 1. The switching converter circuitry 108 includes an example input capacitor 202 (which may be referred to herein as C_{IN} 202, an example primary switches 204 and 206, an example resonant inductor 208 (which may be referred to herein as L_{R} 208), an example magnetizing inductor 210 (which may be referred to herein as L_{M} 210), an example resonant capacitor 212 (which may be referred to herein as C_{R} 212), an example current sense capacitor 214 (which may be referred to herein as C_{SNS} 214) example secondary inductors 216 and 217, example secondary switches 218 and 220, an example output capacitor 222, (which may be referred to herein as C_{OUT} 222), example reference voltage circuitry 224, example control circuitry 226, and example VCR synthesis circuitry 228.

On the primary side of the switching converter circuitry 108, C_{IN} 202 includes a positive terminal coupled to the output of the DC power supply circuitry 106 and negative terminal coupled to ground. Accordingly, the positive terminal of C_{IN} 202 can receive an input voltage (labeled in FIG. 2 as y volts DC) from the DC power supply circuitry 106.

The primary switch 204 includes a first current terminal coupled to the positive terminal of C_{IN} 202 and the output terminal of the DC power supply circuitry 106. The primary switch also includes a control terminal that can receive a High On (HO) signal, a second current terminal. The primary switch 206 includes a first current terminal coupled to the second current terminal of the primary switch 204. The primary switch 206 also includes a control terminal that can receive a Low On (LO) signal and a second current terminal coupled to ground. In some examples, the primary switch 204 is referred to as a high side power transistor and the primary switch 206 is referred to as a low side power transistor.

In general, the primary switch 204 or the primary switch 206 may be referred to as powered ON in response to the switch being in a closed state (e.g., a voltage is applied such that current can flow from the first current terminal to the second current terminal). Conversely, the primary switch 204 or the primary switch 206 may be referred to as powered OFF in response to the switch not being in a closed state (e.g., current cannot flow from the first current terminal to the second current terminal because the voltage across the two terminals is beneath a headroom threshold value, is negative, etc.).

L_{R} 208 includes a first terminal coupled to the second current terminal of the primary switch 204 and the first current terminal of the primary switch 206. The L_{R} 208 also includes a second terminal. Similarly, L_{M} 210 includes a first terminal coupled to the second terminal of L_{R} 208 and a second terminal.

C_{R} 212 includes a positive terminal coupled to the second terminal of L_{M} 210 and a negative terminal coupled to ground. C_{SNS} 214 includes a positive terminal coupled to the negative terminal of C_{R} 212 and the second terminal of L_{M} 210. C_{SNS} 214 also includes a negative terminal.

On the secondary side of the switching converter circuitry 108, the secondary inductor 216 includes a first terminal and a second terminal. The secondary inductor 217 includes a first terminal coupled to the secondary terminal of the secondary inductor 216 and a secondary terminal. L_{M} 210, the secondary inductor 216, and the secondary inductor 217 collectively form a transformer with coils wrapped around different ends of a core material. In some examples, L_{R} 208 is also implemented as part of foregoing transformer to save cost.

In the example of FIG. 2, the core material is ferrite. In other examples, the core is made of a different material. If the state of the primary switches 204 and 206 allow current to flow through L_{M} 210, the current causes magnetism in the core material. As the strength of the magnetic field increases, the field induces a voltage in the coil to oppose the applied voltage and limit the current. In some examples, L_{M} 210 is referred to as the self-inductance of an inductor formed using a magnetic core material (e.g., ferrite).

The secondary switch 218 includes a first current terminal coupled to ground, a control terminal that can receive an input signal (labelled S1 in FIG. 2), and a second current terminal coupled to the first terminal of the secondary inductor 216. The secondary switch 218 also includes a body diode with an anode coupled to its first current terminal and a cathode coupled to its second current terminal.

The secondary switch 220 includes a first current terminal coupled to the first current terminal of the secondary switch 218 and to ground. The secondary switch 220 also includes a control terminal that can receive an input signal (labelled S2 in FIG. 2), and a second current terminal coupled to the second terminal of the secondary inductor 217. The secondary switch 220 also includes a body diode with an anode coupled to its first current terminal and a cathode coupled to its second current terminal.

In the example of FIG. 2, the secondary switches 218 and 220 act as ideal rectifiers. In other examples, the secondary switches 218 and 220 are replaced with diodes. A manufacturer or designer of the switching converter circuitry 108 may choose to implement the secondary switches 218 and 220 instead of diodes because the resistance of the transistor channel can result in lower conduction loss compared to diodes that have approximately 0.4V to 0.7V forward voltage. In general, the secondary switches 218 and 220 may be implemented interchangeably with diodes depending on cost and performance targets of the switching converter circuitry 108.

In the example of FIG. 2, the primary switches 204, 206 and the secondary switches 218, 220 are n-channel metal-oxide semiconductor field-effect transistors (NMOS FETs). Alternatively, the primary switches 204, 206 and the secondary switches 218, 220 may be n-channel field-effect transistors (FETs), n-channel insulated-gate bipolar transistors (IGBTs), n-channel junction field effect transistors (JFETs), NPN bipolar junction transistors (BJTs) and/or, with slight modifications, p-type equivalent devices. The primary switches 204, 206 and the secondary switches 218, 220 may be depletion mode devices, drain-extended devices, enhancement mode devices, natural transistors or other type of device structure transistors. Furthermore, the primary switches 204, 206 and the secondary switches 218, 220 may be implemented in/over a silicon substrate (Si), a silicon carbide substrate (SiC), a gallium nitride substrate (GaN) or a gallium arsenide substrate (GaAs). In examples described above and herein, the term “first current terminal” refers to a drain, the term “control terminal” refers to a gate, and the term “second current terminal” refers to a source of an NMOS FET. In other examples, the terms “current terminal” and “control terminal” may refer to a base, an emitter, a collector, etc., depending on the transistor architecture used to implement one or more of the primary switches 204, 206 and the secondary switches 218, 220.

C_{OUT} 222 includes a positive terminal coupled to the second terminal of the secondary inductor 216, the first terminal of the secondary inductor 217, and the load 110. C_{OUT} 222 also includes a negative terminal coupled to the first current terminal of the secondary switch 218, the first current terminal of the secondary switch 220, and to ground. In some examples, the ground plane coupled to the secondary side of the switching converter circuitry 108 is at a different voltage than the ground plane coupled to the primary side of the switching converter circuitry 108.

The reference voltage circuitry 224 converts the input voltage provided by the DC power supply circuitry 106 to one or more reference voltages (e.g., the Voltage Common Mode (V_{CM}) and the Drain Voltage (V_{DD}) as shown in FIG. 2). In the example of FIG. 2, the reference voltage circuitry 224 is shown within the switching converter circuitry 108. In other examples, the reference voltage circuitry 224 is implemented externally from the switching converter circuitry 108 so that the reference voltages can be used by other components within the power delivery system of FIG. 1.

The control circuitry 226 uses the V_{CM} signal, the V_{DD} signal, and a Resonant Capacitor Voltage (V_{CR}) signal to manage the operations of other components within the switching converter circuitry 108. For example, the control circuitry 226 uses the foregoing input signals to produce the HO signal provided to the primary switch 204, the LO signal provided to the primary switch 206, the S1 signal provided to the secondary switch 218, and the S2 signal provided to the secondary switch 220. The control circuitry 226 also produces two additional switch signals, Q and Q′, that are inverted relative to one another (e.g., Q represents a logical 1 in response to Q′ representing a logical 0, and vice versa). The control circuitry 226 may be implemented with any type of programmable circuitry. Examples of programmable circuitry include but are not limited to programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs).

The VCR synthesis circuitry 228 determines the voltage across the resonant capacitor C_{R} 212. The voltage (which may be referred to above and herein as the V_{CR} signal) is used as an input by the control circuitry 226, thereby forming a feedback loop. To produce the V_{CR} signal, the VCR synthesis circuitry 228 uses the HO, LO, Q and Q′ signals from the control circuitry 226 as inputs. The VCR synthesis circuitry 228 also uses the V_{CM} and V_{DD} signals from the reference voltage circuitry 224, and a signal from the negative terminal of C_{SNS} 214, as inputs to form the V_{CR} signal. As used herein, the signal formed between the negative terminal of C_{SNS} 214 and an input terminal of the VCR synthesis circuitry 228 is referred to a current sense signal (I_{SNS}).

FIG. 2, shows that the switching converter circuitry 108 is an implementation of a half bridge LLC resonant converter device. Accordingly, in some examples, the switching converter circuitry 108 may be referred to as half bridge converter circuitry. In general, half bridge LLC devices perform operations with the presumption that the primary switches 204 and 206 are powered ON for equal amounts of time, and that the average voltage across C_{R} 212 is given by: V_{CR}=V_{IN}/2, where V_{IN} is an input voltage provided to the primary side of the switching converter circuitry 108 (e.g., V_{IN}=Y Volts as shown in in FIG. 2). During CMC operations, however, the value of VCR may shift due in certain use cases. For example, burst mode operation refer to a state where, to meet the specific power requirements of the load 110, the control circuitry 226 sets the HO and LO signals such that the primary switches 204 and 206 power ON and OFF at a relatively high rate of speed. This high rate makes it difficult to maintain volt-second balance (e.g., the principle that the average voltage across the inductor of a transformer ideally remains at zero volts). In half bridge LLC devices, breaking the volt-second balance results in a shift to the value of V_{CR} that, if the left unchecked, can cause flux walking and current sharing issues.

Flux walking generally refers to the successive accumulation of flux in a magnetic core ultimately leading to its saturation. Operating in saturation mode unintentionally can damage the core and cause unexpected behavior. Current sharing generally refers to the primary and secondary sides of an isolated voltage regulator sharing current equally to provide more load current or redundant power to a load. Performing current sharing incorrectly or unintentionally may damage the load, damage the switching converter circuitry 108, and cause unexpected behavior. Accordingly, if left unregulated, a shift in the value of C_{R} 212 can degrade the performance of the switching converter circuitry 108.

Other half bridge LLC resonant converter devices use various techniques to regulate the value of a resonant capacitor. Some such devices do so by forcing the width of a pulse in the HO signal to be equal to the width of the pulse in a LO signals (e.g., forcing the primary switches 204 and 206 to be powered ON for equal amounts of time). In general, C_{R} 212 charges in response to primary switch 204 being powered ON and primary switch 206 being powered OFF. Conversely, C_{R} 212 discharges in response to primary switch 206 being powered ON and primary switch 204 being powered OFF. Therefore, setting one of the HO or LO signals to remain at a logical ‘1’ (thereby closing the corresponding primary switch) for the exact length of time that the other signal was previously at a logical ‘1’ can lead to an approximately equal amount of time spent charging and discharging C_{R} 212. However, during burst mode operations, the HO and LO signals flip between a logical ‘1’ and ‘0’ at a sufficiently high rate of speed that the control circuitry 226 cannot accurately measurement the pulse width of one signal (e.g., LO) and mimic the results in the other signal (e.g., HO). Therefore, half bridge LLC resonant converter devices that attempt to force the primary switches to have equal ON times still struggle to perform in burst mode operations.

Other approaches attempt to sense the voltage of C_{R} 212 directly by including a resistor divider across C_{R} 212. Once the voltage of C_{R} 212 is known, control circuitry can then adjust the HO and LO signals to increase the charge or discharge time as needed to counteract any shifts away from the value of V_{IN}/2. However, the switching converter circuitry 108 and the resistor divider are generally implemented on separate integrated circuits (ICs). Using such a technique, therefore, requires the presence of a pin on the IC holding the switching converter circuitry 108 that serves the dedicated purpose of coupling C_{R} 212 to the resistor divider. Such a dedicated pin adds to the cost and complexity of implementing the IC. Furthermore, implementing a resistor divider within the same IC that implements the switching converter circuitry 108 would also be cost prohibitive because components within said IC require a relatively high voltage rating (e.g., above 630V in some use cases).

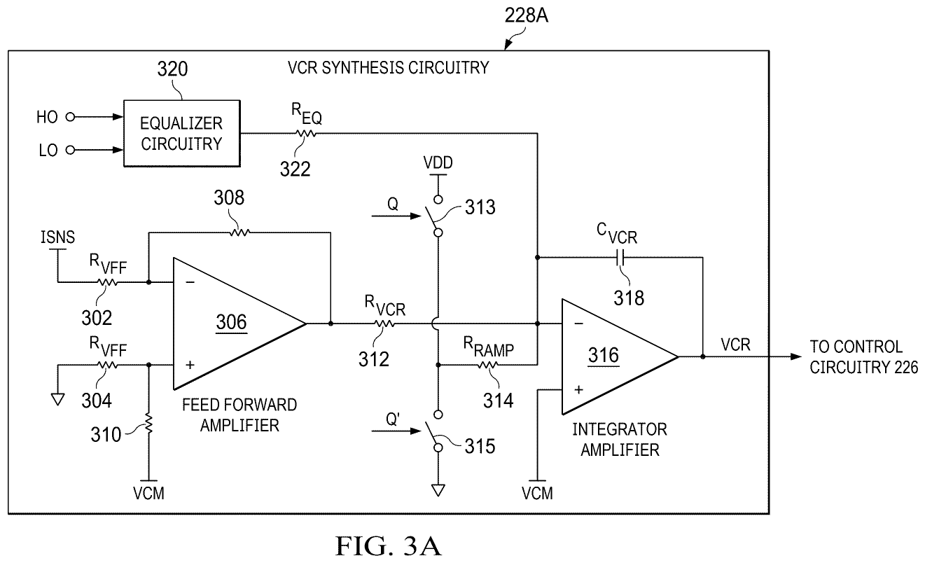

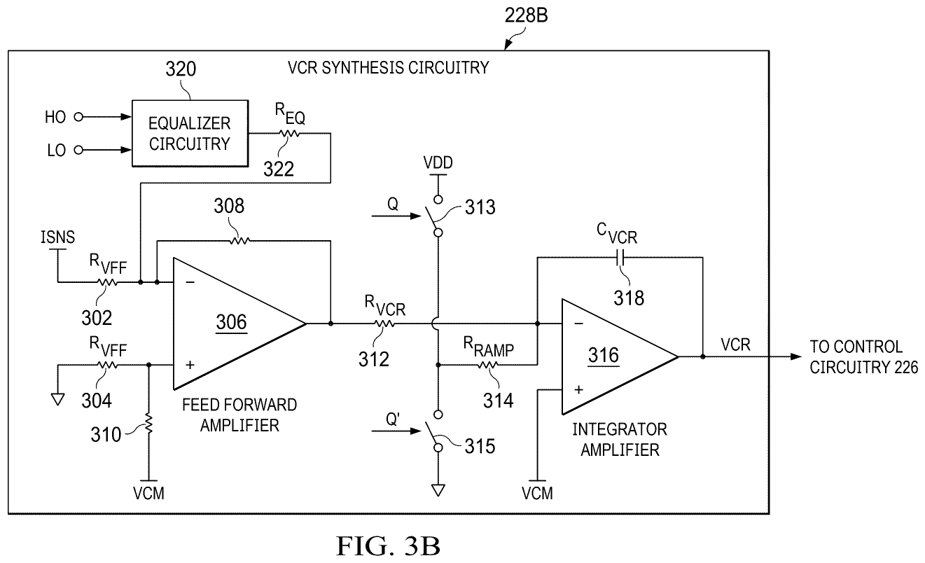

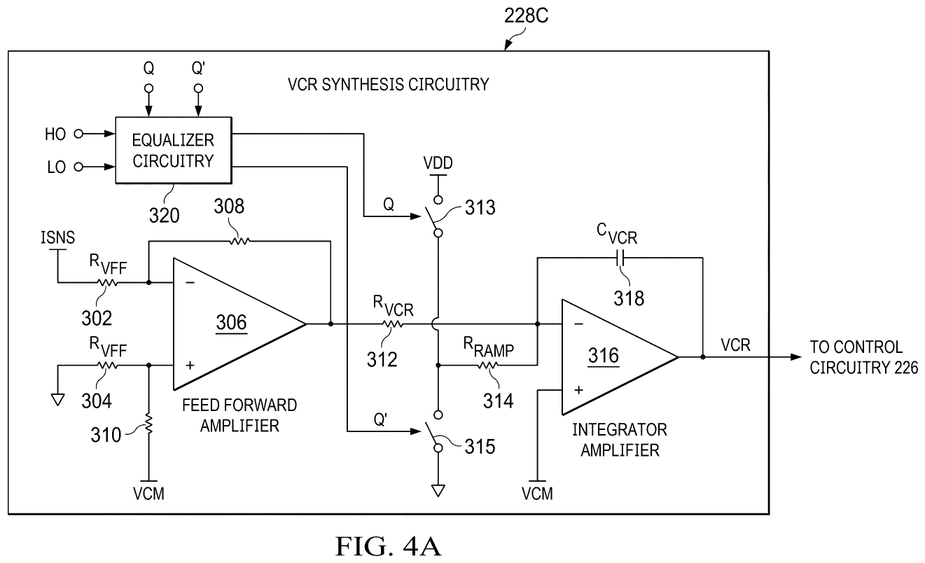

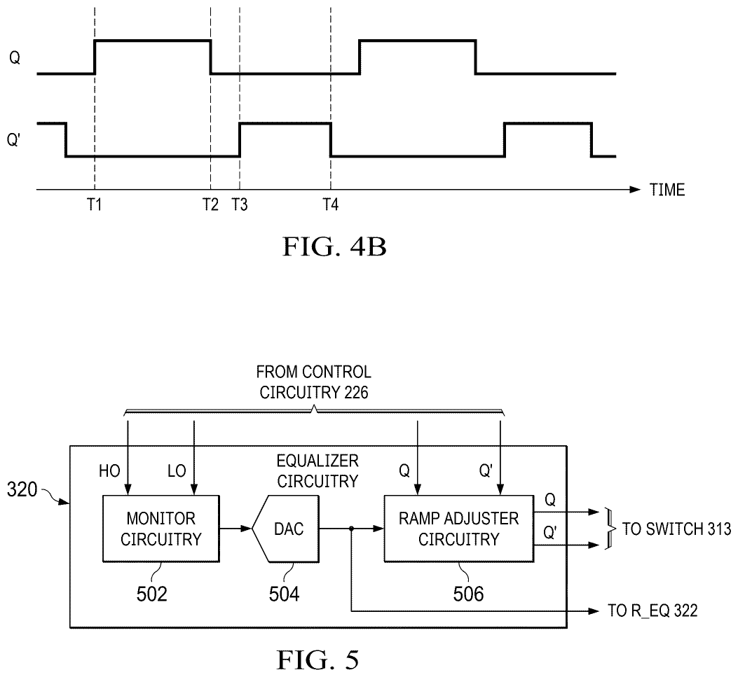

In examples described herein, the switching converter circuitry 108 does not implement the foregoing techniques to monitor the voltage of C_{R} 212. Rather, the switching converter circuitry 108 includes the VCR synthesis circuitry 228. The VCR synthesis circuitry 228 integrates current from the I_{SNS} signal to form an internal representation of V_{CR}. By implementing the VCR synthesis circuitry 228 on the same IC as the switching converter circuitry 108, the IC can support a wider variety of power requirements from the load 110 than other power management devices. Such power requirements may include, but are not limited to, very high frequency startup with controlled inrush currents and feed forward gain stage. The use of the internal VCR synthesis circuitry 228 also makes the IC less susceptible to external noise, making the IC more robust. The VCR synthesis circuitry 228 is described further in connection with FIGS. 3A, 3B, and 4A.

FIG. 3A is an example block diagram of a first implementation of the Voltage Resonant Capacitor (VCR) synthesis circuitry of FIG. 2. FIG. 3A labels this first implementation as VCR synthesis circuitry 228A. VCR synthesis circuitry 228A includes example feed forward voltage resistors 302 and 304 (which may be referred to herein as RVFF 302 and 304), an example feed forward amplifier 306, example resistors 308 and 310, an example VCR resistor 312 (which may be referred to herein as R_{VCR} 312), example switches 313 and 315, an example ramp resistor 314 (which may be referred to herein as R_{RAMP} 314), an example integrator amplifier 316, an example resonant capacitor voltage capacitor (which may be referred to herein as C_{VCR} 318), example equalizer circuitry 320, and an example equalizer resistor (which may be referred to herein as R_{EQ} 322).

R_{VFF} 302 includes a first terminal that receives the I_{SNS} signal from C_{SNS} 214 and a second terminal. R_{VFF} 304 includes a first terminal coupled to ground and a second terminal. The feed forward amplifier 306 includes a first input terminal coupled to the second terminal of R_{VFF} 302, a second input terminal coupled to the second terminal of R_{VFF} 304, and an output terminal. The resistor 308 includes a first terminal coupled to the first terminal of the feed forward amplifier 306 and a second terminal coupled to the output terminal of the feed forward amplifier 306. The resistor 310 includes a first terminal that can receive the V_{CM} signal from the reference voltage circuitry 224 and a second terminal coupled to the second input terminal of the feed forward amplifier 306. R_{VCR} 312 includes a first terminal coupled to the output terminal of the feed forward amplifier 306 and a second terminal.

R_{VFF} 302 and 304, the feed forward amplifier 306, the resistors 308-310, and R_{VCR} 312 collectively form a feed forward stage of the VCR synthesis circuitry 228. The feed forward stage works to increase the magnitude of the I_{SNS} current signal by multiplying the I_{SNS} signal with the gain of the feed forward amplifier.

The switch 313 includes a first terminal that receives V_{DD} from the reference voltage circuitry and a second terminal. The switch 313 is opened and closed responsive to the Q signal provided by the control circuitry 226. R_{RAMP} 314 includes a first terminal coupled to the second terminal of the switch 313 and a second terminal. The switch 315 includes a first terminal coupled to the second terminal of the switch 313 and the first terminal of R_{RAMP} 314. The switch 315 also includes a second terminal coupled to ground.

The switches 313 and 315 and R_{RAMP} 314 may be collectively referred to as ramp circuitry within the VCR synthesis circuitry 228. The ramp circuitry introduces a ramp signal that is used in conjunction with the signal from the feed forward stage (e.g., the amplified current signal) to determine V_{CR}. In response to the control circuitry 226 setting the Q signal to a logical 1 and Q′ signal to a logical 0, the switch 313 is closed, the switch 315 is opened, and the ramp signal is implemented by charging C_{VCR} 318. Conversely, in response to the control circuitry 226 setting the Q signal to a logical 0 and the Q′ signal to a logical 1, the switch 313 is opened, the switch 315 is closed, and the ramp signal is implemented by discharging C_{VCR} 318. The control circuitry 226 determines the timing of the Q and Q′ signals responsive to the value of the HO and LO signals. For example, the control circuitry 226 triggers a pulse in the Q signal at the falling edge of the LO signal and triggers a pulse in the Q′ signal the falling edge of the HO signal.

The integrator amplifier 316 includes a first input terminal coupled to the second terminal of R_{VCR} 312 and the second terminal of R_{RAMP} 314. The integrator amplifier 316 also includes a second input terminal that can receive V_{CM} from the reference voltage circuitry 224. The integrator amplifier 316 also includes an output terminal that provides the value of V_{CR} to the control circuitry 226. C_{VCR} 318 includes a positive terminal coupled to the second terminal of R_{RAMP} 314 and a negative terminal coupled to the output terminal of the integrator amplifier 316.

The integrator amplifier 316 and C_{VCR} 318 collectively implement an integrator stage of the VCR synthesis circuitry 228. The sum of both the signal from the feed forward amplifier 306 and the ramp signal represent the current flowing through the C_{R} 212. Thus, by integrating the sum of both signals, the integrator amplifier 316 can determine the voltage cross C_{R} 212.

The use of the feed forward amplifier 306 and the integrator amplifier 316 can introduce errors. An offset voltage refers to the DC voltage that needs to be applied across the input terminals of an amplifier in order to force the DC output voltage to 0 V. An ideal amplifier is balanced in the sense that it has an offset voltage of 0 V (e.g., no voltage is needed across the input terminals). In practice, process variation and design constraints cause a nonzero offset voltage. The offset voltage adds to the input voltage on one of the terminals of an amplifier, thereby causing the output voltage of the amplifier to be inaccurate. Thus, other half bridge resonant converter LLCs that use an amplifier to integrate a current signal still suffer from flux walking and current sharing problems because offset error leads to an inaccurate value of VCR being provided to a control circuitry.

Example methods, apparatus, and systems described herein correct for inaccuracies to VCR measurements within half bridge LLC resonant converter devices. Example equalizer circuitry compares the amount of time that primary switch 204 is powered ON with the amount of time that the primary switch 206 is powered ON. If the difference between the power ON times exceeds a threshold, the equalizer circuitry 320 can inject or remove an amount of current into the VCR synthesis circuitry 228 responsive to the magnitude of the difference. The equalizer circuitry 320 can also add an amount asymmetry into the ramp stage of the VCR synthesis circuitry 228 responsive to the magnitude of the difference. Because the control circuitry 226 determines the power ON times (e.g., the values of the HO and LO signals) based on the value of V_{CR}, the equalizer circuitry can correct for any source of error that causes V_{CR} to shift. Such sources of error include but are not limited to offset error from the feed forward amplifier 306, offset error from the integrator amplifier 316, and burst mode operations as described above. Accordingly, devices implemented according to the teachings herein can use a more accurate V_{CR} signal to exhibit less flux walking and current sharing issues than other devices.

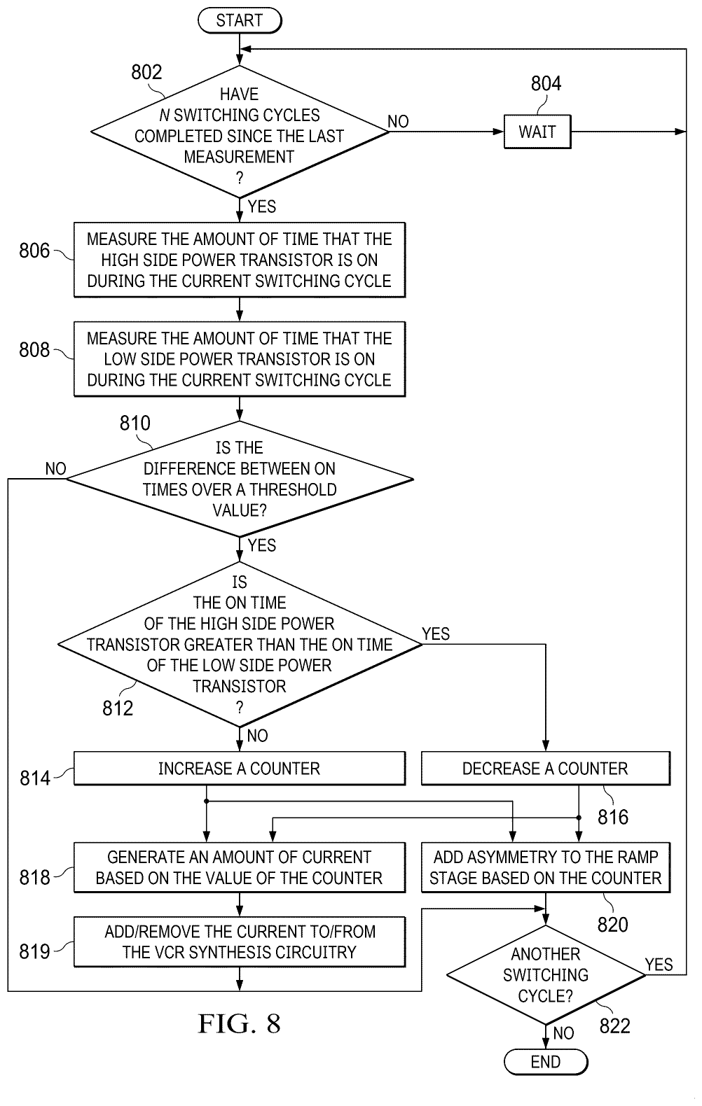

The equalizer circuitry 320 described in examples herein may be instantiated (e.g., creating an instance of, bring into being for any length of time, materialize, implement, etc.) by programmable circuitry such as a Central Processor Unit (CPU) executing first instructions. Furthermore, the equalizer circuitry 320 of FIGS. 3A, 3B, and 4A may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. Some or all of the circuitry of FIGS. 3A, 3B, and 4A may, thus, be instantiated at the same or different times. Some or all of the circuitry of FIGS. 3A, 3B, and 4A may be instantiated, for example, in one or more threads executing concurrently on hardware and/or in series on hardware. Moreover, in some examples, some or all of the circuitry of FIGS. 3A, 3B, and 4A may be implemented by microprocessor circuitry executing instructions and/or FPGA circuitry performing operations to implement one or more virtual machines and/or containers. In some examples, the equalizer circuitry 320 is instantiated by programmable circuitry executing equalizer instructions and/or performs operations such as those represented by the flowchart(s) of FIG. 8.

The equalizer circuitry 320 uses the HO and LO signals from the control circuitry 226 to increase the accuracy of the VCR output provided to the control circuitry 226, thereby correcting for errors as described above. The equalizer circuitry 320 can cause the integrator amplifier 316 to provide a corrected value of V_{CR} through a variety of techniques. In the example of FIG. 3A, the output of the equalizer circuitry 320 is coupled to a first terminal of R_{EQ} 322. FIG. 3A also shows the second terminal of R_{EQ} 322 coupled to the second terminal of R_{RAMP} 314, the positive terminal of C_{VCR} 318, and the negative input terminal of the integrator amplifier 316. Accordingly, the equalizer circuitry 320 injects or removes an amount of current at the integrator amplifier 316 that counteracts the offset error caused by both amplifiers.

FIG. 3B is an example block diagram of a second implementation of the VCR synthesis circuitry of FIG. 2. FIG. 3B labels this second implementation as VCR synthesis circuitry 228B. The VCR synthesis circuitry 228B includes the same components as VCR synthesis circuitry 228A. However, FIG. 3A shows the second terminal of R_{EQ} 322 coupled to an input terminal of the integrator amplifier 316, while FIG. 3B shows the second terminal of R_{EQ} 322 coupled to R_{VFF} 302, the resistor 308, and the negative input terminal of the feed forward amplifier 306. Accordingly, the equalizer circuitry 320 described in the teachings herein can counteract the shifts to V_{CR} by adding an offset voltage to either of the amplifiers in the VCR synthesis circuitry.

FIG. 4A is an example block diagram of a third implementation of the Voltage Resonant Capacitor (VCR) synthesis circuitry of FIG. 2. FIG. 4A labels this third implementation as VCR synthesis circuitry 228C. The VCR synthesis circuitry 228C includes the same components as FIGS. 3A and 3B except for R_{EQ} 322. In FIGS. 3A and 3B, a first output terminal of the equalizer circuitry 320 couples to a first terminal of R_{EQ} 322 and the second terminal of R_{EQ} 322 couples to a terminal elsewhere within the VCR synthesis circuitry 228. In FIG. 4A, a second and third terminal of the equalizer circuitry 320 couple to the input terminals of the switches 313 and 315, respectively. In such examples, the equalizer circuitry 320 obtains the original versions of the Q and Q′ signals from the control circuitry 226 and provides a modified version of Q and Q′ signals to the input terminals of the switches 313 and 315, respectively

Rather than injecting or removing current into an input terminal of the amplifier, FIG. 4A shows that the equalizer circuitry 320 can also correct for V_{CR} shifting errors by adding asymmetry to the Q and Q′ signals. An example of such asymmetry is shown in FIG. 4B. In the configurations of FIGS. 3A and 3B, the control circuitry 226 causes the Q and Q′ signals to be symmetric in that both signals exhibit a logical ‘1’ for the same amount of time exhibit a logical ‘0’ for the same amount of time. Such a configuration causes C_{VCR} 318 to charge and discharge for equal amounts of time. In other configurations of the VCR synthesis circuitry 228 described in the teachings herein, the equalizer circuitry 320 causes the Q signal to exhibit a logical ‘1’ for a different amount of time than the Q′ signal. In FIG. 4B, for example, (T2-T1)≠(T4-T3). The change in the Q and Q′ signals cause the C_{VCR} 318 to charge and discharge for an unequal amount of time, thereby changing an input to the integrator amplifier 316 and producing a more accurate value of V_{CR}.

FIG. 5 is an example block diagram of the equalizer circuitry of FIGS. 3A, 3B, and 4A. The equalizer circuitry 320 may include example monitor circuitry 502, example Digital to Analog Converter (DAC) circuitry 504, and example ramp adjuster circuitry 506.

The monitor circuitry 502 measures the HO signal received from the control circuitry 226 to determine the amount of time that the power switch 204 is powered ON. Similarly, the monitor circuitry 502 measures the LO signal received from the control circuitry 226 to determine the amount of time that the power switch 206 is powered ON. The monitor circuitry 502 may include any suitable interface components and perform any suitable measurement techniques to determine the foregoing power ON times.

The monitor circuitry 502 also monitors for errors within the switching converter circuitry 108 by comparing the power ON time of the power switch 204 to the power ON time of the switch 206. In some examples, the difference between the power ON times quantifies an error with the value of V_{CR} used by the control circuitry 226. The error may occur for any reason, including but not limited to offset errors from amplifiers and issues maintaining volt-second balance in burst mode as described above. In such examples, the monitor circuitry 502 produces a digital counter value based on the difference in power ON times. The monitor circuitry 502 may be implemented using any type of programmable circuitry. The operations performed by the monitor circuitry 502 are described further in connection with FIG. 8.

The DAC circuitry 504 converts the digital counter value into an analog signal. In the examples of FIGS. 3A and 3B, one output terminal of the equalizer circuitry 320 is coupled the DAC circuitry 504 to R_{EQ} 322. Accordingly, the output of the DAC circuitry 504 includes a precise amount of current that can either be injected into or removed from the VCR synthesis circuitry 228 such that the accuracy of the value of V_{CR} increases.

The ramp adjuster circuitry 506 uses the analog signal from the DAC circuitry 504 to adjust the values of the Q and Q′ signals provided by the control circuitry 226. In some examples, the ramp adjuster circuitry 506 uses the DAC circuitry 504 output to adjust the width of a pulse by an amount that is proportional to the counter value. In other examples, the ramp adjuster circuitry 506 is not coupled to the DAC circuitry 504 and uses a different technique to adjust the width of a pulse by an amount that is proportional to the counter value. Changing the width of a pulse in the Q or Q′ signal causes the amount of time spent charging C_{VCR} 318 to be different than the amount of time spent discharging C_{VCR} 318, thereby changing an input to the integrator amplifier 316 and increasing the accuracy of the corresponding V_{CR} value. The ramp adjuster circuitry 506 may be implemented using any type of programmable circuitry. The operations performed by the ramp adjuster circuitry 506 are described further in connection with FIG. 8.

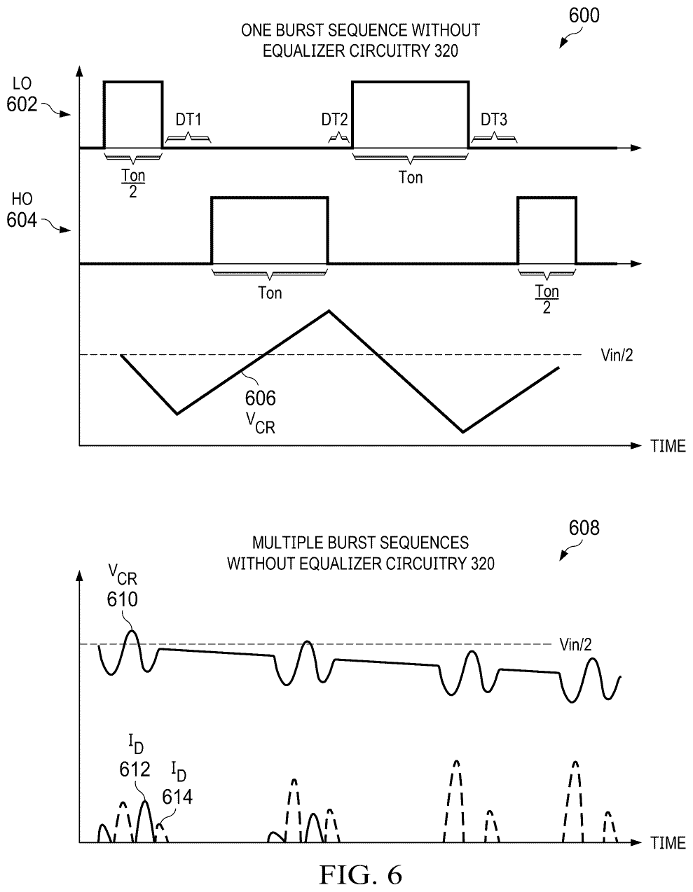

FIG. 6 is a graph illustrating operations of VCR synthesis circuitry that does not include the equalizer circuitry of FIGS. 3A, 3B, and 4A. FIG. 6 includes an example graph 600, which includes example LO signal 602, an example HO signal 604, and an example V_{CR} signal 606. FIG. 6 also includes an example graph 608, which includes an example V_{CR} signal 610, and example current diode signals 612 and 614 (which may be referred to herein as ID signal 612 and 614).

The graph 600 shows one burst sequence that occurs within a half bridge LLC resonant converter device that does not implement the equalizer circuitry 320. The LO signal 602 is an example implementation of the LO signal generated by the control circuitry 226. As such, a high voltage (e.g., a logical ‘1’) in the LO signal 602 indicates the primary switch 206 is powered ON and in a closed state, while a low voltage (e.g., a logical ‘0’) indicates the primary switch 206 is powered OFF. Similarly, the HO signal 604 is an example implementation of the HO signal generated by the control circuitry 226. As such, a high voltage in the HO signal 604 indicates the primary switch 204 is powered ON and in a closed state, while a low voltage (e.g., a logical ‘0’) indicates the primary switch 204 is powered OFF.

As described above, burst mode refers to a mode of operation where the power requirements set by the load device cause the primary switches 204 and 206 to alternate between power ON and OFF states at a relatively high frequency. As such, in FIG. 6, the values of DT1, DT2, and DT3 (which refer to periods during which both the primary switches 204 and 206 are powered OFF) are relatively small. The small lengths of these periods make it difficult for the controller circuitry 226 to maintain the volt-second balance on the transformer (formed by L_{M} 210, the secondary inductor 216, and the secondary inductor 217) as described above. Furthermore, because the graph 600 shows a half bridge LLC resonant converter without the equalizer circuitry 320, the feed forward amplifier 306 and the integrator amplifier 316 introduce offset error into the device. As a result of these errors, the device described in FIG. 6 exhibits an imbalance to the voltage across C_{R} 212 over the course of a single burst operation. For example, in FIG. 6, the V_{CR} signal 606 starts at exactly (V_{IN}/2) when the burst sequence begins (e.g., when the LO signal 602 transitions to a high voltage) but ends below (V_{IN}/2) once the burst sequence ends (e.g., when the HO signal 604 transitions to a low voltage).

The graph 608 shows multiple burst sequences that occur within a half bridge LLC resonant converter device that does not implement the equalizer circuitry 320. In particular, the graph 600 shows one burst sequence, while the graph 608 shows four burst sequences that are separated by periods where both primary switches 204 and 206 are powered OFF. As a result, the graph 608 refers to a greater amount of time than the graph 600.

The V_{CR} signal 610 shows that, if left unregulated, the imbalance shown in the V_{CR} signal 606 can accumulate over time (e.g., the average value of V_{CR} continues to drift further away from the desired value of (V_{IN}/2)). The accumulated shift in V_{CR} causes imbalance on the secondary side of the switching converter circuitry 108 that can negatively affect performance. For example, the I_{D} signal 612 represents the amount of current flowing through the body diode of the secondary switch 218, and the I_{D} signal 614 represents the amount of current flowing through the body diode of the secondary switch 220. The graph 608 shows that I_{D} signal 612 and I_{D} signal 614 start with equal magnitude but become unbalanced due to the accumulated shift in V_{CR}.

The unequal amounts of current flowing through the diodes on the secondary side of the circuit may lead to one or more of the secondary switches 204, 206 exceeding their current rating. The unequal amounts of current may also cause an imbalance of the Magnetic Flux Density-Magnetic Field (B-H) curve of the transformer core to be exceeded such that the one or more of the inductors operate in saturation mode. Accordingly, unequal amounts of current can cause current sharing issues, flux walking, damage to one or more components within the electronic device of FIG. 1, and the load 110 receiving an unexpected amount of power. As a result, power management devices that do not include the equalizer circuitry 320 and perform as shown in FIG. 6 may be unable to support a load 110 that requires power to be delivered in burst mode.

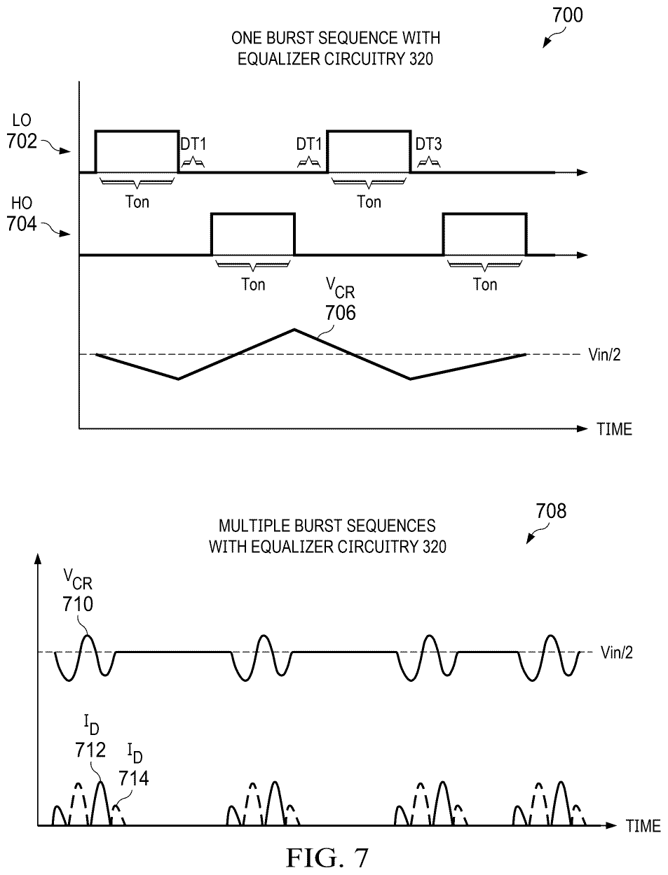

FIG. 7 is a graph illustrating operations of VCR synthesis circuitry 228 that does include the equalizer circuitry of FIGS. 3A, 3B, and 4A. FIG. 7 includes an example graph 700, which includes example LO signal 702, an example HO signal 704, and an example V_{CR} signal 706. FIG. 7 also includes an example graph 708, which includes an example V_{CR} signal 710, and example current diode signals 712 and 714 (which may be referred to herein as I_{D} signal 712 and 714).

FIG. 7 shows how an example device implemented according to the teachings described herein (e.g., a half bridge LLC resonant converter with the equalizer circuitry 320) responds to the same inputs as the example of FIG. 6. That is, graph 700 and graph 600 both refer to a single burst sequence caused by the same power requirements of the load 110. Similarly, the graph 708 and graph 608 both refer to a sequence of four bursts that occur over a longer period of time than is shown in graphs 700 and 600.

In the example of FIG. 7, the burst mode operation still makes maintaining volt-second balance on the transformer difficult, and the feed forward amplifier 306 and the integrator amplifier 316 still introduce offset error into the VCR synthesis circuitry 228. However, the equalizer circuitry 320 measures the LO signal 702 and HO signal 704 to determine the cumulative effect of the foregoing sources of error. If the difference between the pulse widths of the LO signal 702 and HO signal 704 exceeded a threshold (e.g., if the difference between the power ON times of the primary switches 204 and 206 exceed the threshold), the equalizer circuitry 320 performs operations to the other components of the VCR synthesis circuitry 228 such that the value of V_{CR} sent to the control circuitry 226 is artificially shifted. As a result, the control circuitry 226 receives a value of V_{CR} that is higher or lower than it would have been if the equalizer circuitry 320 did not perform any operations. This change to V_{CR} makes the value a more accurate representation of the voltage across C_{R} 212 because the offset error of the amplifiers made the initial V_{CR} value inaccurate. The operations of the equalizer circuitry 320 are described further in connection with FIG. 8.

The more accurate value of V_{CR} causes the control circuitry 226 to adjust the HO and LO signals in a manner that addresses both sources of error. As a result, the graph 700 shows the LO signal 702 and HO signal 704 have equal pulse widths, (labeled T_{ON} in FIG. 7), and the V_{CR} signal 706 is balanced because it both starts and ends at (V_{IN}/2). Moreover, if operations in burst mode or offset error temporarily cause the value of V_{CR} to shift, the shift causes the control circuitry 226 to temporary make the pulse widths of the LO signal 702 and HO signal 704 unequal, which can in turn trigger the equalizer circuitry 320. Thus, the teachings described herein implement a feedback loop that prevents the error from accumulating over time (as shown in graph 708 by the average value of V_{CR} signal 710 remaining at (V_{IN}/2) over time, and by the I_{D} signals 712 and 714 maintaining equal magnitudes over time).

In contrast, the device of FIG. 6 can use V_{CM} synthesis circuitry to detect if burst mode operations have caused a shift in V_{CM}. However, without the equalizer circuitry 320, the value of VCM reported to control circuitry in the device of FIG. 6 is inaccurate, so said control circuitry can never fully correct for both sources of error. Accordingly, power management devices implemented with the equalizer circuitry 320 perform better and support a wider variety of use cases (e.g., power requirements from the load 110) than devices without the equalizer circuitry 320.

FIG. 8 is a flowchart representative of example machine-readable instructions and/or example operations that may be executed, instantiated, and/or performed using an example programmable circuitry implementation of the equalizer circuitry 320 of FIGS. 3A, 3B, and 4A. The example machine-readable instructions and/or the example operations 800 of FIG. 8 begin when the monitor circuitry 502 determines if N switching cycles have completed since a last measurement. (Block 802). In block 802, N refers to any positive integer. A switching cycle refers to a period in which both the high side primary switch 204 and the low side primary switch 206 open and close once. In FIGS. 6 and 7, a switching cycle is visually represented as one pulse (e.g. a transition from a digital ‘0’ to a digital ‘1’ and back to a digital ‘0’) in the LO signal 602 and 702, followed by a pulse in the corresponding HO signal 604 and 704. The measurement of block 802 refers to the measurements described further below in connection with blocks 806 and 808.

If N switching cycles have not yet completed since the last measurement (Block 802: No), the monitor circuitry 502 waits (Block 804) for at least one switching cycle to complete until control returns to block 802. The monitor circuitry 502 implements block 802 because, in some examples, errors in the switching converter circuitry 108 cause the value of the HO and LO signals to change gradually. Thus, by refraining from performing measurements whenever the controller circuitry 226 provides a nonzero value in the HO or LO signals, the equalizer circuitry 320 can reduce computational resource usage while still accurately monitoring for errors.

If N switching cycles have completed since the last measurement (Block 802: Yes), the monitor circuitry 502 measures the amount of time that the high side primary switch 204 is powered ON during the current switching cycle. (Block 806). To do so, the monitor circuitry 502 measures the pulse width of the HO signal sent from the control circuitry 226 to the control terminal of the primary switch 204. In examples described herein, the measurement of block 806 is referred to the power ON time of primary switch 204 or the power ON time of the high side power transistor.

The monitor circuitry 502 measures the amount of time that the low side primary switch 206 is powered ON during the current switching cycle. (Block 808). To do so, the monitor circuitry 502 measures the pulse width of the HO signal sent from the control circuitry 226 to the control terminal of the primary switch 204. In examples described herein, the measurement of block 808 is referred to the power ON time of primary switch 206 or the power ON time of the low side power transistor.

The monitor circuitry 502 determines whether the difference between the power ON times is over a threshold value. (Block 810). In some examples, the threshold value is 3% of the power ON time of the power switch 204. In other examples, the threshold value is a different value. The threshold value may be either related to or independent of the power ON time of a primary switch. If the equalizer circuitry 320 determines whether the difference between the power ON times is below a threshold value (Block 810: No), the machine-readable instructions or operations 800 proceed to block 822.

If the monitor circuitry 502 determines whether the difference between the power ON times is over the threshold value (Block 810: Yes), the monitor circuitry 502 determines whether the power ON time of the high side power transistor is greater than the power ON time of the low side power transistor. (Block 812). If the power ON time of the primary switch 204 is less than the power ON side of the primary switch 206 (Block 812: No), the monitor circuitry 502 increases a counter value. (Block 814). Similarly, if the power ON time of the primary switch 204 is greater than the power ON side of the primary switch 206, the monitor circuitry 502 decreases a counter value. The counter may be any type of integer or floating-point value. By executing blocks 812-816, the equalizer circuitry 320 establishes a counter value that quantifies the amount of shift in V_{CR}.

After block 814 or 816, the DAC circuitry 504 generates an amount of current based on the value of the counter. (Block 818). The DAC circuitry 504 then adds the current to or removes the current from the VCR synthesis circuitry. (Block 819). For example, suppose V_{CM}=2.5V. If the counter causes the output of the DAC circuitry 504 to also be equal to 2.5V, then the difference between power ON times is less than a threshold value (Block 810: No), and the equalizer circuitry 320 does not perform current injection or current removal.

Within the same example where V_{CM}=2.5V, suppose instead the difference in power ON times is greater than the threshold value (Block 810: Yes) and the execution of blocks 814 or 816 causes the DAC circuitry 504 to be greater than 2.5V. In such an example, the equalizer circuitry may inject or remove an amount of current at block 819 proportional to the counter (e.g., the larger the DAC circuitry 504 output is, the more current is injected). Similarly, if the counter causes the DAC circuitry 504 output to be less than 2.5V, then the equalizer circuitry 320 may remove (e.g., act as a current sink) an amount of current at block 819 proportional to the counter (e.g., the smaller the larger the DAC circuitry 504 output is, the more current is sunk by the equalizer circuitry 320).

After block 814 or 816, the ramp adjuster circuitry 506 may generate an amount of asymmetry to the ramp stage of the VCR synthesis circuitry 228 based on the counter. (Block 820). The equalizer circuitry 320 adds asymmetry by turning the switch 313 ON for a different amount of time than switch 315, thereby charging or discharging C_{VCR} 318 for an unequal amount of time. To do so, the ramp adjuster circuitry 506 makes the pulse width of the Q signal different than the pulse width of the Q′ signal as shown in FIG. 4B.

By adding asymmetry to the ramp stage, the equalizer circuitry 320 changes an input to the integrator amplifier 316 by an amount that is proportional to the counter value. For example, suppose again that V_{CM}=2.5V, that the difference in power ON times is greater than the threshold value (Block 810: Yes), and the result of blocks 814 or 816 is that the DAC circuitry 504 output is greater 2.5V. In such an example, the ramp adjuster circuitry 506 may increase the pulse width of Q signal proportional to the current value (e.g., the larger the DAC circuitry 504 output is, the greater the longer the pulse width in the Q signal is). Similarly, if the counter causes the DAC circuitry 504 output to be less than 2.5V, then ramp adjuster circuitry 506 may decrease the pulse width of the Q signal proportional to the current value (e.g., the smaller the DAC circuitry 504 output is, the shorter the pulse width of the Q signal is). In some examples, the ramp adjuster circuitry 506 changes the pulse width of the Q′ signal instead of the Q signal.

As shown in FIG. 5, the equalizer circuitry 320 may include three output terminals: two output terminals to adjust the Q and Q′s signals as described in block 820, and one output terminal to inject or remove current as described in block 819. In some examples, the equalizer circuitry 320 either: a) injects or removes current with an amplifier, or b) adds asymmetry to the ramp stage (e.g., blocks 818 and 819 are implemented mutually exclusively from block 820). A manufacturer or designer of the equalizer circuitry 320 may choose which technique to use to adjust the value of V_{CR} based on tradeoffs between the size and simplicity of the implementation vs simplicity. For example, the implementation shown in FIG. 4A does not include Req 222 but does require implementation of the ramp adjuster circuitry 506 in FIG. 5. Conversely, the implementations shown in FIG. 3A and 3B do include Req 222 but do not require implementation of the ramp adjuster circuitry 506 in FIG. 5.

After blocks 818 and 819 and/or block 820, the monitor circuitry 502 determines if another switching cycle will occur. (Block 822). The presence of additional switching cycles is based on the power requirements of the load 110 and may depend on any number of factors (e.g., whether the load 110 is powered off, entered a sleep state, is performing operations, etc.) If another switching cycle is to occur (Block 822: Yes), control returns to block 802 where the monitor circuitry 502 determines whether N switches have completed since the last execution of blocks 806 and 808. If another switching cycle does not occur (Block 82: No), the example machine-readable instructions and/or operations 800 end.

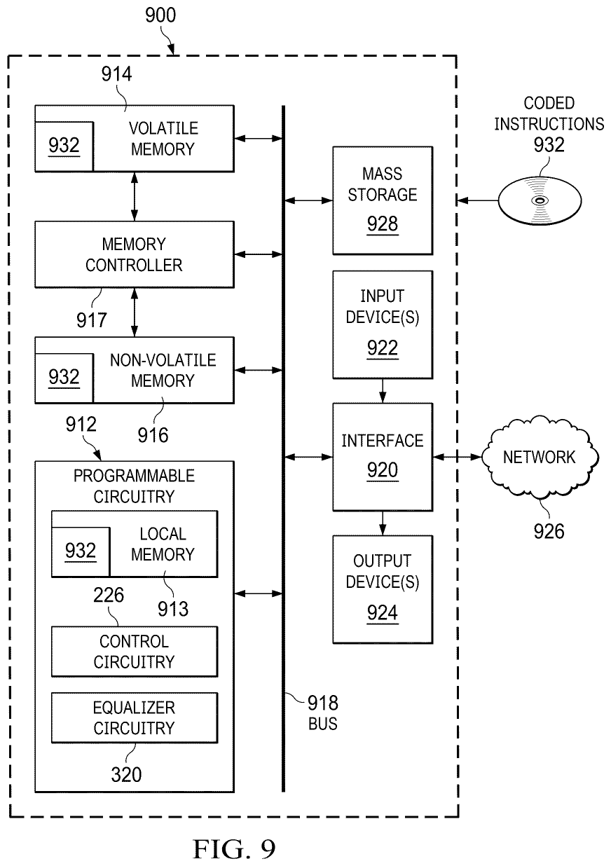

FIG. 9 is a block diagram of an example programmable circuitry platform 900 structured to execute and/or instantiate the example machine-readable instructions and/or the example operations of FIG. 8 to implement the equalizer circuitry 320 of FIGS. 3A, 3B, and 4A. The programmable circuitry platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, FPGAs, microprocessors, CPUs, GPUs, DSPs, and/or microcontrollers from any desired family or manufacturer. The programmable circuitry 912 may be implemented by one or more semiconductor based (e.g., silicon based) devices. In this example, the programmable circuitry 912 implements the control circuitry 226 and the equalizer circuitry 320.

The programmable circuitry 912 of the illustrated example includes a local memory 913 (e.g., a cache, registers, etc.). The programmable circuitry 912 of the illustrated example is in communication with main memory 914, 916, which includes a volatile memory 914 and a non-volatile memory 916, by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916.

The programmable circuitry platform 900 of the illustrated example also includes interface circuitry 920. The interface circuitry 920 may be implemented by hardware according to any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, an audio sensor, a microphone, a camera (still or video), a keyboard, a button, a mouse, a touchscreen, a trackpad, a trackball, an isopoint device, and/or a voice recognition system.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 900 of the illustrated example also includes one or more mass storage discs or devices 928 to store firmware, software, and/or data. Examples of such mass storage discs or devices 928 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 932, which may be implemented by the machine-readable instructions of FIG. 8, may be stored in the mass storage device 928, in the volatile memory 914, in the non-volatile memory 916, and/or on at least one non-transitory computer readable storage medium such as a CD or DVD which may be removable.

While an example manner of implementing the VCR synthesis circuitry 228 of FIG. 2 is illustrated in FIGS. 3A, 3B, and 4A, one or more of the elements, processes, and/or devices illustrated in FIGS. 3A, 3B, and 4A may be combined, divided, re-arranged, omitted, eliminated, and/or implemented in any other way. Further, any of the monitor circuitry 502, the DAC circuitry 504, the ramp adjuster circuitry 506, and, more generally, components of the equalizer circuitry 320 of FIGS. 3A, 3B, and 4A, may be implemented by hardware alone or by hardware in combination with software and/or firmware. Thus, for example, any of the monitor circuitry 502, the DAC circuitry 504, the ramp adjuster circuitry 506, and, more generally, components of the equalizer circuitry 320 of FIGS. 3A, 3B, and 4A, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the equalizer circuitry 320 of FIGS. 3A, 3B, and 4A may include one or more elements, processes, and/or devices in addition to, or instead of, those illustrated in FIG. 5, and/or may include more than one of any or all of the illustrated elements, processes and devices.

Flowchart(s) representative of example machine-readable instructions, which may be executed by programmable circuitry to implement and/or instantiate the equalizer circuitry 320 of FIGS. 3A, 3B, and 4A and/or representative of example operations which may be performed by programmable circuitry to implement and/or instantiate the equalizer circuitry 320 of FIGS. 3A, 3B, and 4A, are shown in FIG. 8. The machine-readable instructions may be one or more executable programs or portion(s) of one or more executable programs for execution by programmable circuitry such as the programmable circuitry 912 shown in the example programmable circuitry platform 900 described below in connection with FIG. 9 and/or may be one or more function(s) or portion(s) of functions to be performed by the example programmable circuitry (e.g., an FPGA). In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIG. 8, many other methods of implementing the example equalizer circuitry 320 may alternatively be used. For example, the order of execution of the blocks of the flowchart(s) may be changed, and/or some of the blocks described may be changed, eliminated, or combined. Furthermore, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C #, Perl, Python, JavaScript, HyperText Markup Language (HTML), Structured Query Language (SQL), Swift, etc.

As mentioned above, the example operations of FIG. 8 may be implemented using executable instructions (e.g., computer readable and/or machine-readable instructions) stored on one or more non-transitory computer readable and/or machine-readable media. As used herein, the terms non-transitory computer readable medium, non-transitory computer readable storage medium, non-transitory machine-readable medium, and/or non-transitory machine-readable storage medium are expressly defined to include any type of computer readable storage device and/or storage disk and to exclude propagating signals and to exclude transmission media. Examples of such non-transitory computer readable medium, non-transitory computer readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine-readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” refers to implementations including any of (1) at least one A, (2) at least one B, or (3) at least one A and at least one B. Similarly, as used herein in the context of describing structures, components, items, objects and/or things, the phrase “at least one of A or B” refers to implementations including any of (1) at least one A, (2) at least one B, or (3) at least one A and at least one B. As used herein in the context of describing the performance or execution of processes, instructions, actions, activities, etc., the phrase “at least one of A and B” refers to implementations including any of (1) at least one A, (2) at least one B, or (3) at least one A and at least one B. Similarly, as used herein in the context of describing the performance or execution of processes, instructions, actions, activities, etc., the phrase “at least one of A or B” refers to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Furthermore, although individual features may be included in different examples or claims, these may possibly be combined, and the inclusion in different examples or claims does not imply that a combination of features is not feasible and/or advantageous.

Unless specifically stated otherwise, descriptors such as “first,” “second,” “third,” “fourth,” etc., are used herein without imputing or otherwise indicating any meaning of priority, physical order, arrangement in a list, and/or ordering in any way, but are merely used as labels and/or arbitrary names to distinguish elements for ease of understanding the described examples. In some examples, the descriptor “first” may be used to refer to an element in the detailed description, while the same element may be referred to in a claim with a different descriptor such as “second” or “third.” In such instances, such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real-world imperfections. For example, “approximately” and “about” may indicate such dimensions may be within a tolerance range of +/−10% unless otherwise specified herein.

As used herein, the phrase “in communication,” including variations thereof, encompasses direct communication and/or indirect communication through one or more intermediary components, and does not require direct physical (e.g., wired) communication and/or constant communication, but rather also includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

In the description and claims, described “circuitry” may include one or more circuits. A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

Circuits described herein are reconfigurable to include the replaced components to provide functionality at least partially similar to functionality available prior to the component replacement. Components shown as resistors, unless otherwise stated, are generally representative of any one or more elements coupled in series and/or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other examples, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description.

Modifications are possible in the described examples, and other examples are possible, within the scope of the claims.

From the foregoing, it will be appreciated that example systems, apparatus, articles of manufacture, and methods have been described that correct for inaccuracies to VCR measurements within half bridge LLC resonant converter devices. Described systems, apparatus, articles of manufacture, and methods improve the efficiency of using a computing device by measuring the difference between the amount of time that the primary switches are powered ON. When the difference exceeds a threshold, example equalizer circuitry described herein can inject an amount of current into the VCR synthesis circuitry responsive to the magnitude of the difference. The equalizer circuitry can also add an amount asymmetry into the ramp stage of the VCR synthesis circuitry responsive to the magnitude of the difference. In doing so, the equalizer circuitry reports a more accurate reading of VCR to control circuitry, thereby increasing the performance of the power management device and mitigating more (e.g., flux walking and current sharing) than other devices. Described systems, apparatus, articles of manufacture, and methods are accordingly directed to one or more improvement(s) in the operation of a machine such as a computer or other electronic and/or mechanical device.

What is claimed is:

1. An apparatus comprising:
monitor circuitry configured to:
determine a first transistor within half bridge converter circuitry is powered on for a first amount of time during a switching cycle of the half bridge converter circuitry;
determine a second transistor within the half bridge converter circuitry is powered on for a second amount of time during the switching cycle; and
digital to analog converter (DAC) circuitry coupled to the monitor circuitry, the DAC circuitry configured to inject an amount of current into the half bridge converter circuitry to correct an error, the amount of the current based on a difference between the first amount of time and the second amount of time.

2. The apparatus of claim 1, wherein:
the half bridge converter circuitry includes the first transistor, the second transistor, an inductor, a resonant capacitor, and control circuitry; and
the control circuitry is configured to operate the first transistor and the second transistor responsive to a voltage across the resonant capacitor.

3. The apparatus of claim 2, wherein the half bridge converter circuitry further includes:
a feed forward amplifier configured to amplify a magnitude of a current signal that describes the current flowing through the resonant capacitor;
ramp circuitry coupled to the feed forward amplifier, the ramp circuitry to add a ramp signal to the amplified current signal; and
an integrator amplifier coupled to the ramp circuitry, the integrator amplifier configured to integrate an output of the ramp circuitry to produce a value that describes the voltage across the resonant capacitor.

4. The apparatus of claim 3, wherein the error corrected by the current injection includes:
a first error corresponding to the switching cycle; and
a second error caused by the feed forward amplifier and the integrator amplifier.

5. The apparatus of claim 4, wherein:
the first error is caused by a break in volt-second balance across the inductor;
the half bridge converter circuitry is configured to operate the first transistor and the second transistor in a burst mode; and
the break in volt-second balance occurs during the burst mode.

6. The apparatus of claim 3, wherein the DAC circuitry is configured to inject the current into an input terminal of the integrator amplifier.

7. The apparatus of claim 3, wherein the DAC circuitry is configured to inject the current into an input terminal of the feed forward amplifier.

8. The apparatus of claim 3, further including ramp adjuster circuitry coupled to the DAC circuitry, the ramp adjuster circuitry configured to change a magnitude of the ramp signal based on the difference between the first amount of time and the second amount of time.

9. The apparatus of claim 8, wherein:
the ramp circuitry includes a first switch and a second switch;
the magnitude of the ramp signal is based on a third amount of time that the first switch is closed and a fourth amount of time that the second switch is closed; and
the ramp adjuster circuitry is configured to change the magnitude of the ramp signal by increasing the third amount of time so that the third amount of time is unequal to the fourth amount of time.

10. The apparatus of claim 9, wherein the ramp adjuster circuitry is configured to increase the third amount of time by an amount that is proportional to the difference between the first amount of time and the second amount of time.

11. The apparatus of claim 1, wherein the DAC circuitry injects the current responsive to a determination that the difference between the first amount of time and the second amount of time exceeds a threshold.

12. The apparatus of claim 11, wherein, responsive to a determination the difference between the first amount of time and the second amount of time exceeds the threshold:
the monitor circuitry is configured to increase a counter value responsive to a determination that the first amount of time is greater than the second amount of time; and
the DAC circuitry is configured to inject an amount of current proportional to the counter value.

13. An apparatus comprising:
half bridge converter circuitry including a first transistor, a second transistor, an inductor, and a resonant capacitor; and
synthesis circuitry coupled to the half bridge converter circuitry, the synthesis circuitry configured to determine a voltage across the resonant capacitor;
equalizer circuitry coupled to the synthesis circuitry, the equalizer circuitry configured to:
determine the first transistor is powered on for a first amount of time during a switching cycle of the half bridge converter circuitry;
determine the second transistor is powered on for a second amount of time during the switching cycle; and
remove an amount of current into the synthesis circuitry to correct an error in a value of the voltage across the resonant capacitor, the amount of the current based on a difference between the first amount of time and the second amount of time; and
the half bridge converter circuitry is configured to:
receive an input voltage from power supply circuitry;
convert the input voltage into an output voltage based on the corrected value of the voltage across the resonant capacitor; and
provide the output voltage to a load.

14. The apparatus of claim 13, wherein the equalizer circuitry is further configured to:
generate the output voltage having a magnitude responsive to the amount of current flowing through the inductor; and
determine the amount of current flowing through the inductor based on the voltage across the resonant capacitor.

15. The apparatus of claim 13, wherein to determine the voltage across the resonant capacitor, the synthesis circuitry is configured to integrate a signal that represents the current flowing through the resonant capacitor.

16. The apparatus of claim 13, wherein:
the synthesis circuitry includes at least one amplifier that is used to generate a signal that represents the current flowing through the resonant capacitor; and
the error corrected by the current removal includes an offset error caused by the at least one amplifier.

17. The apparatus of claim 13, wherein:
the error corrected by the current removal includes an error caused by a break in volt-second balance across the inductor;
the half bridge converter circuitry is configured to operate the first transistor and the second transistor in a burst mode; and
the break in volt-second balance occurs during the burst mode.

18. The apparatus of claim 13, wherein, responsive to a determination the difference between the first amount of time and the second amount of time is below a threshold, the equalizer circuitry is configured to:
decrease a counter value responsive to a determination that the first amount of time is greater than the second amount of time; and
remove an amount of current proportional to the counter value.

19. A non-transitory machine-readable storage medium comprising instructions to cause programmable circuitry to at least:
determine a first transistor within half bridge converter circuitry is powered on for a first amount of time during a switching cycle of the half bridge converter circuitry;
determine a second transistor within the half bridge converter circuitry is powered on for a second amount of time during the switching cycle; and
inject an amount of current into the half bridge converter circuitry to correct an error, the amount of the current based on a difference between the first amount of time and the second amount of time.

20. The non-transitory machine-readable storage medium of claim 19, wherein:
the half bridge converter circuitry includes the first transistor, the second transistor, an inductor, a resonant capacitor, and control circuitry;
the control circuitry is configured to operate the first transistor and the second transistor responsive to a voltage across the resonant capacitor; and
the instructions cause the programmable circuitry to correct the error by injecting the amount of current such that an accuracy of a value used by the control circuitry to determine the voltage across the resonant capacitor is increased.
